(19) United States
(12) Patent Application Publication
(10) Pub. No.: US 2012/0053916 A1
(43) Pub. Date: Mar. 1, 2012

(54) SYSTEM AND METHOD FOR DETERMINING FLIGHT PERFORMANCE PARAMETERS

(76) Inventor: Aviv Tzidon, Tel Aviv (IL)

(21) Appl. No.: 12/868,999

(22) Filed: Aug. 26, 2010

(51) Int. Cl. G06G 7/48

(52) U.S. Cl. 703/8

(57) ABSTRACT

A method is disclosed for enhancing estimation of parameters for an aircraft simulator having a simulation model and covariance matrix. According to embodiments of the invention the method comprising providing a first estimation of predetermined parameters of the aircraft's maneuvers performance, performing maneuvers with the aircraft, collecting actual flight data over a time representing the maneuvers of the aircraft, dividing the actual flight data into segments with quasi-constant velocity, feeding recorded flight control data of each segment into the simulation model, comparing output from the simulation model with actual flight data to determine an error vector and updating the covariance matrix and the estimation of the desired parameters using the error vector.

### FIELD OF THE INVENTION

The present invention relates to the field of avionics, more particularly to improved high performance flight.

### BACKGROUND OF THE INVENTION

Increasingly pilots are using simulators to acquire, maintain, and improve their skills. The simulators simulate the six degrees of freedom (DOF): the ability to move in each of three dimensions and the ability to change angle around three perpendicular axes. The simulators are based on data provided by the aircraft manufacturer. However, the data is usually not accurate enough since the aircraft designs are continuously modified, creating the very real possibility that the documentation provided to the simulator developer is not updated to account for the modifications.

Moreover, it is customary for simulator consumers to apply an Acceptance Test Procedure (ATP) to the simulator. The ATP is performed by the simulator buyer's pilots, whose evaluation is subjective and cannot provide an absolute quantitative approval of the flight parameters implemented in the simulator.

Therefore, it is an object of the present invention is to provide objective quantitative benchmarks for evaluating 6-DOF simulator performance. Another object is to suggest better coefficients for calibrating the flight model covariants of the 6-DOF equations.

Another problem in high-performance flight is that many systems that provide warnings about mid-air collisions extrapolate from the flight vectors of the two aircraft, trying to evaluate the miss distance between the two vectors. For commercial flights where the flight profile is predictable, the rate of false alarms is relatively small. However, this is not the case for high maneuverability aircraft like fighter jets and training aircraft where the force capabilities can be up to 9 G or more.

Extrapolation in these cases generates a lot of false alarms. Even with non-linear extrapolation, the errors of the extrapolations are too great, creating high false alarm rate and influencing the users not to trust the warnings. Existing extrapolation systems don't take into account variable parameters that change dynamically in flight.

For example: the weight of an aircraft is the sum of its fixed weight (the aircraft frame) and variable weight (number of passengers, fuel, disposable fuel tanks, and, for combat aircraft, weapons.

The total weight not only fluctuates from day to day, it also changes during the flight itself due to fuel consumption. Aircraft total weight on takeoff can easily be double that of landing.

The lift of an aircraft is what makes it maneuverable. The lift of a specific aircraft is fixed since it is being created by the aircraft frame (mainly the wings) and is derived as follows: F=M*A (Force=lift, Mass=weight, Acceleration=maneuverability).

Since F is fixed, and M and A are linearly connected, aircraft maneuverability is very low at takeoff and only reaches full maneuverability towards the end of the flight (when the weight of the fuel and ammunition are at their lowest).

Therefore, another object of the present invention is to increase the accuracy of aircraft flight vector extrapolation using a software module that continually compares the extrapolated path to the actual flight path. By monitoring aircraft performance, the system analyzes aircraft maneuverability and determines among other variable parameters the changes in the aircraft weight, which is used to improve the flight path extrapolations.

The software module maintains and dynamically updates flight vector extrapolation to account for dynamic factors during flight, like weather, weight, etc., which can affect the accuracy of the extrapolation.

By continuously comparing the results of the extrapolation to the actual flight path, the software module can automatically modify the database, improving subsequent flight vector extrapolations.

### SUMMARY OF THE INVENTION

There is thus provided, in accordance with some preferred embodiments of the present invention, a method for enhancing estimation of desired parameters for aircraft simulator having a simulation model and covariance matrix, the method comprising:

providing a first estimation of predetermined parameters;

collecting actual flight data over a time;

dividing the actual flight data into segments with quasi-constant velocity;

feeding recorded flight control data of each segment into the simulation model;

comparing output from the simulation model with actual flight data to determine error vector;

updating the covariance matrix and the estimation of the desired parameters using the error vector.

Furthermore, in accordance with some preferred embodiments of the present invention, the method further comprises iteratively applying the method of claim 1 for each segment until an accepted level of accuracy is met.

Furthermore, in accordance with some preferred embodiments of the present invention, the method is carried out in-flight.

Furthermore, in accordance with some preferred embodiments of the present invention, the desired parameters are selected from the group containing: calibrated airspeed, true airspeed, pressure, altitude, air density, ambient temperature, climbing rate, angle of attack α, normal acceleration G number (Ng), sideslip angle β, side acceleration, pitch yaw and roll rates (p,q,r), pitch yaw and roll Euler angles (ψ,θ,φ), longitudinal acceleration, engine RPM, fuel quantity, weapon configuration, aircraft weight and flight control data selected from the group containing: stick & pedal positions, elevator, ailerons and rudder deflections, flaps (leading & trailing edges) deflection, throttle position, engine RPM, fuel quantity, weapon configuration, aircraft weight and weather condition.

Furthermore, in accordance with some preferred embodiments of the present invention, there is provided a method for determining specific values of a set of predetermined performance parameters for a specific aircraft for which manufacturer-supplied data on the predetermined performance parameters is initially provided, the method comprising:

performing with the aircraft maneuvers for which the manufacturer-supplied data applies and comparing the maneuver data with the manufacturer-supplied data;

establishing a database of the specific values of the predetermined performance parameters, associated with the specific aircraft.

Furthermore, in accordance with some preferred embodiments of the present invention, the predetermined performance parameters are selected from the group containing: aircraft position, velocity vector, attitude angles, roll rate, turn acceleration factor and angle of attack.

Furthermore, in accordance with some preferred embodiments of the present invention, the method is used in determining flight path extrapolation.

Furthermore, in accordance with some preferred embodiments of the present invention, the method further comprises feeding the specific values into an airborne database for flight path extrapolation.

Furthermore, in accordance with some preferred embodiments of the present invention, the method further comprises applying the method for each pilot from a group of pilots, thus establishing a database of the specific values of the predetermined performance parameters, associated with the specific aircraft and with each of the pilots.

Furthermore, in accordance with some preferred embodiments of the present invention, the method is used in determining flight path extrapolation.

Furthermore, in accordance with some preferred embodiments of the present invention, the method further comprises feeding the specific values into an airborne database for flight path extrapolation.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram of parameter estimation in accordance with a preferred embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements

### DETAILED DESCRIPTION OF EMBODIMENTS OF THE PRESENT INVENTION

The simulator developer (or vendor) and simulator customer agree on the level of accuracy the simulator should provide. Once the 6-DOF (Degrees Of Freedom) modules are ready to be tested, an ATP (Acceptance Test Procedure) is created. The reference for the aircraft's performance is a set of a real aircraft flight path recordings.

This set of reference flight recordings (RFR) is fed to the software engine which then combines this information with the 6-DOF modules. Multiple runs are performed in order to tune the relevant covariances.

Each time the system performs another run, the merit number for the simulation accuracy is increased up to the agreed level.

Aircraft simulation comprises the following modules:
Aircraft aerodynamics including Mach-dependent static and dynamic coefficients and aircraft-configuration-dependent coefficients. In this context aircraft configuration can include weapons, fuel tanks, etc. and the dependent coefficients can include drag, etc.
Aircraft engine thrust (and thrust vectoring if available) and fuel consumption model, which depends on velocity, air density and temperature.
Aircraft dynamics, comprising the 6-DOF (Degree Of Freedom) equations of motion.
Aircraft inertial parameters (weight, moments of inertia, gravity center), which depend on fuel quantity, weapons and armament deployment.
Avionics, designation, countermeasures, etc. according to customer requirements.

The parameters that required tuning are those of the first two modules: aerodynamics and engine thrust. All the other module parameters can be a priori estimated with good enough accuracy.

The first step in the tuning process is to come up with initial estimates of the desired parameters: zero order estimation. Knowing the aircraft's basic configuration and aerodynamic control configuration, and some basic aircraft engine data, a skilled aeronautic engineer can carry out the desired zero order estimation.

The second step is to record the required flight data, which can include:
Mach, calibrated airspeed (CAS) and true airspeed (TAS), pressure, altitude, air density, ambient temperature, climbing rate.
Angle of attack α, normal acceleration G number (Ng), sideslip angle β, side acceleration, pitch yaw and roll rates (p,q,r), pitch yaw and roll Euler angles (ψ,θ,φ), longitudinal acceleration
Control settings: stick and pedal positions, elevator, ailerons and rudder deflections, flaps (leading and trailing edges) deflection, throttle position, engine revolutions per minute (RPM).
Fuel quantity, weapon configuration, aircraft weight.

The third step is to divide the total flight time into segments with quasi-constant Mach numbers. Each segment's control setting history is fed into the simulation model and the simulation output (α, β, p,q,r, ψ,θ,φ, CAS & TAS, Ng . . . ) is compared with the original flight data to produce the error vector with which the covariance matrix and the desired parameter estimation is updated.

The procedure described above is repeated for each Mach segment. For each segment the best estimation of the desired simulation parameters is achieved, thereby providing the velocity-dependent table of the parameters.

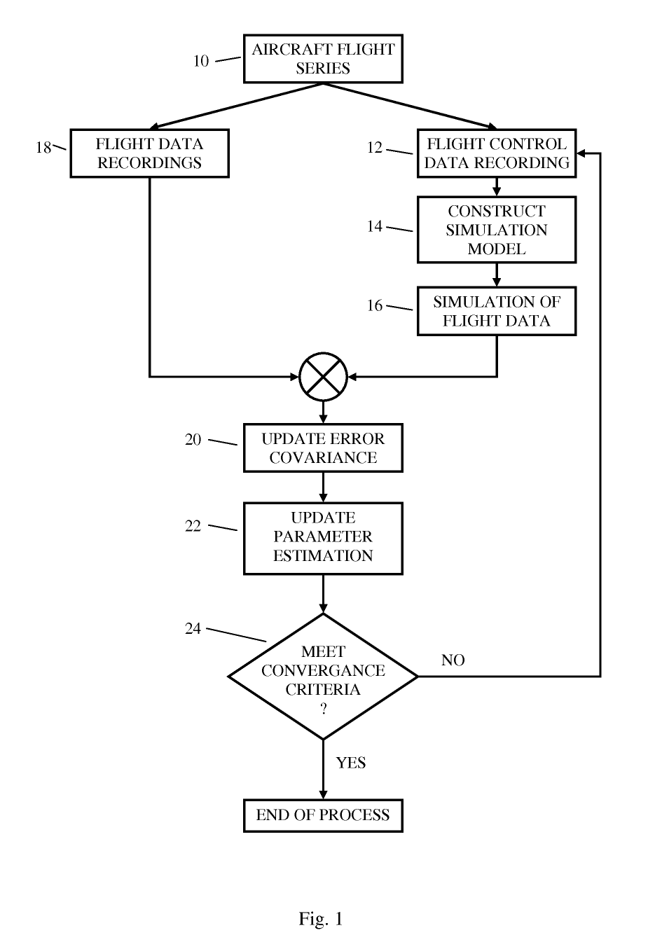

As more flight data is accrued, it can be added to the estimation process to determine iteratively whether better convergence criteria and better estimation can be achieved. The parameter estimation procedure is summarized in the block diagram in FIG. 1:
In block 10, a series of flights are made.
In block 12, the data from the aircraft controls (stick, throttle, etc.) from the series is recorded.
In block 14, based on the data, a simulation model is constructed by the simulation software.
In block 16, simulated flight data is generated by the simulation software.
In block 18, the actual flight data from the series is recorded.
In block 20, the error covariance is updated.
In block 22, the aerodynamics and engine parameter estimates are updated.
In block 24, the new estimates are compared with predefined convergence criteria.
If the estimates meet the criteria, the procedure stops, otherwise the process repeats (more actual flight data is gathered, etc.).

In another embodiment, the present invention provides improved automatic flight vector extrapolation by filtering and tuning the manufacturer-supplied performance database for that particular aircraft type.

Variable external factors influence the extrapolation of the flight vector. These factors need to be analyzed and tuned in real time, thereby improving the extrapolation results. In other words, different planes of the same type of aircraft perform slightly differently. Moreover, different pilots perform differently on the same plane. It is advantageous to set up a database containing performance parameters associated with specific pilot on a specific plane.

The following list provides some examples of parameters that can be used as inputs for the automated flight vector extrapolation algorithm:
Aircraft position
Aircraft velocity vector
Aircraft attitude angles (ψ, θ, φ)
Roll rate (P)
Turn acceleration factor (Ng)
Angle of attack (α)

The automated flight vector extrapolation algorithm comprises two main procedures:
1. Analyzing over time the aircraft performance and comparing the results with the manufacturer-supplied performance database for that specific aircraft type. This procedure comprises:
   A. Performing maneuvers included in the manufacturer-supplied performance database and comparing the results with the database
   B. Analyzing which aircraft maneuvers the pilot performed and at which points in the flight.
   C. Creating a set of variable parameters (SVP) associated with a specific pilot and specific aircraft by combining the results of step A and step B.
2. Feeding the SVP to the aircraft database for better future aircraft flight path extrapolation.

It should be clear that the description of the embodiments and attached drawing set forth in this specification serves only for a better understanding of the invention, without limiting its scope.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A method for enhancing estimation of parameters for aircraft simulator having a simulation model and covariance matrix, the method comprising:
providing a first estimation of predetermined parameters;
performing maneuvers with an aircraft;
collecting actual flight data over a time representing the maneuvers of said aircraft;
dividing the actual flight data into segments with quasi-constant velocity;
feeding recorded flight control data of each segment into the simulation model;
comparing output from the simulation model with actual flight data to determine error vector; and
updating the covariance matrix and the estimation of the desired parameters using the error vector.

2. The method of claim 1, further comprising iteratively applying the method of claim 1 for each segment until an accepted level of accuracy is met.

3. The method of claim 1, wherein it is earned out in-flight.

4. The method of claim 1, wherein the desired parameters are selected from the group containing: calibrated airspeed, true airspeed, pressure, altitude, air density, ambient temperature, climbing rate, angle of attack a, normal acceleration G number (Ng), sideslip angle P, side acceleration, pitch yaw and roll rates (p,q,r), pitch yaw and roll Euler angles longitudinal acceleration, engine RPM, fuel quantity, weapon configuration, aircraft weight and flight control data selected from the group containing: stick & pedal positions, elevator, ailerons and rudder deflections, flaps (leading & trailing edges) deflection, throttle position, engine RPM, fuel quantity, weapon configuration, aircraft weight and weather condition.

5. A method for enhancing estimation of a set of predetermined performance parameters for a specific aircraft, the method comprising:
providing a first estimation of said predetermined performance parameters;
performing maneuvers with the aircraft for which the provided data applies;
collecting actual flight data over time;
comparing the actual flight data with the provided data; and
updating said predetermined performance parameters based on said comparison.

6. The method of claim 5, wherein the predetermined performance parameters are selected from the group containing: aircraft position, velocity vector, attitude angles, roll rate, turn acceleration factor and angle of attack.

7. The method of claim 5, used in determining flight path extrapolation.

8. The method of claim 7, further comprising feeding the specific values into an airborne database for flight path extrapolation.

9. The method of claim 5, further comprising applying the method for each pilot from a group of pilots, thus establishing a database of the specific values of the predetermined performance parameters, associated with the specific aircraft and with each of the pilots.

10. The method of claim 9, used in determining flight path extrapolation.

11. The method of claim 10, further comprising feeding the specific values into an airborne database for flight path extrapolation.

12. The method of claim 5, wherein said first estimation of said predetermined performance parameters is provided by the manufacturer of said specific aircraft.
